(19) United States
(12) Patent Application Publication
(10) Pub. No.: US 2010/0314178 A1
(43) Pub. Date: Dec. 16, 2010

(54) COMBINED WEIGHING AND POINTING APPARATUS

(76) Inventor: Lee Wayne Vantine, Charleston, SC (US)

Correspondence Address: K&L Gates LLP;IP Docketing, 630 HANSEN WAY, PALO ALTO, CA, 94304, US

(21) Appl. No.: 12/484,069

(22) Filed: Jun. 12, 2009

(51) Int. Cl. G01G 19/52

(52) U.S. Cl. 177/245

(57) ABSTRACT

The subject matter disclosed herein provides various embodiments of an apparatus that can function as both a weighing device and a pointing device. In one aspect, the apparatus may include a housing and a housing cover. The housing may include a base having a weighing platform positioned on top of the base and a display for presenting information. The base may further include a weighing mechanism, a motion mechanism and one or more user-control buttons to be operated by users when using the apparatus for weighing. One or more controllers may also be positioned on the base. The one or more controllers may be operated by users when using the apparatus as a pointing device.

### FIELD

Apparatus embodiments for combined weighing and pointing are described herein. In particular, a combined weighing and pointing apparatus that can, according to some aspects, take weight measurements and also function as a computer mouse are provided.

### BACKGROUND

A weighing scale is a measuring instrument for measuring the weight or mass of an object. Weighing scales are used in many industrial and commercial settings, such as mailrooms, laboratories, retail stores and hospitals, to name a few. Many of these settings require the manipulation of various data for analysis, for example weight readings, and often include a computer system positioned in close proximity to a weighing scale to be utilized for such analysis.

### SUMMARY

The subject matter disclosed herein provides various embodiments of an apparatus functional as both a weighing device (e.g., a scale) and a pointing device (e.g., a computer mouse).

In some aspects, the combined weighing and pointing apparatus includes a housing and a housing cover. The housing may include a base having a weighing platform positioned on top of the base and a display for presenting information. In some aspects, the base may further include a weighing mechanism, a motion mechanism and one or more user-control buttons to be operated by users when using the combined weighing and pointing apparatus as a weighing scale. One or more controllers may also be positioned on the base. The one or more controllers may be operated by users when using the combined weighing and pointing apparatus as a computer mouse. When the housing cover is positioned on top of the housing, the apparatus may serve as a computer mouse, such that the controllers are in communication with the motion mechanism for moving a cursor on a computer display screen.

The subject matter described herein provides many advantages. For example, the weighing scale is combined with one of the most commonly available devices of the modern world. Thus, the generation of data (e.g., weight or mass data) may be generated by a device that is already an essential component of a data processing system, i.e., a computer system.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed in the detailed description and drawings.

### BRIEF DESCRIPTION OF THE DRAWINGS

The accompanying drawings are incorporated herein and constitute a part of this disclosure. The drawings show certain aspects of the subject matter disclosed herein and, together with the description, help explain some of the principles associated with the disclosed implementations. In the drawings,

FIG. 1 is a top-down perspective view of an exemplary combined weighing and pointing apparatus.

FIG. 2 is a bottom view of an exemplary combined weighing and pointing apparatus.

FIG. 3 is a top-down perspective view of an exemplary combined weighing and pointing apparatus.

FIG. 4 is an elevational view of an exemplary combined weighing and pointing apparatus.

Similar reference numerals in the drawings are intended to denote similar structures or other features of the described subject matter.

### DETAILED DESCRIPTION

Exemplary combined weighing and pointing apparatus embodiments are provided. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention.

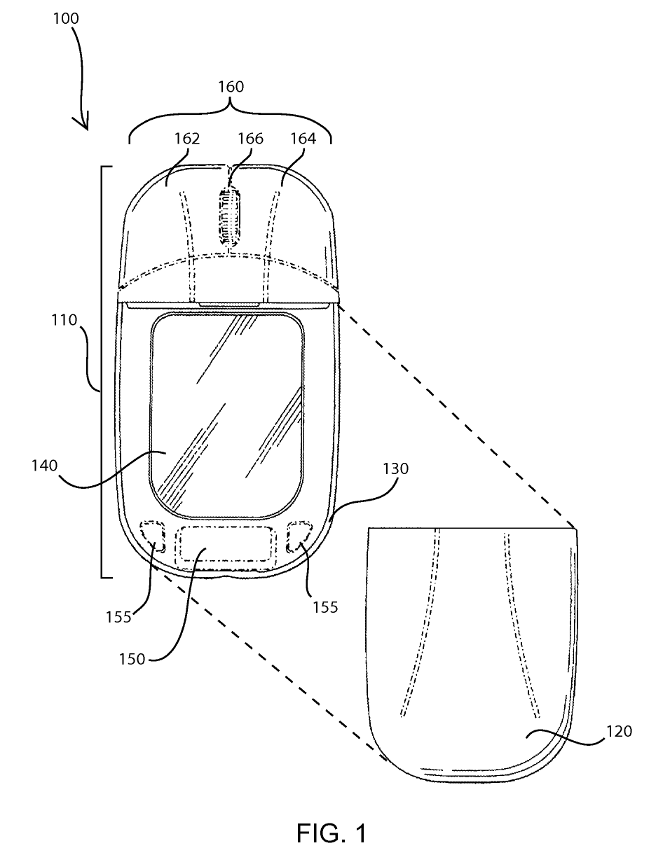

FIG. 1 shows a combined weighing and pointing apparatus 100. The term “weighing” as used herein refers to measuring the weight of an object. The term “pointing” as used herein refers to controlling a user interface to input data or provide commands to a computer using physical movements such as pointing, clicking and/or dragging. Exemplary pointing devices include without limitation a computer mouse, touchpad or trackball. In some aspects, the pointing device is preferably a computer mouse.

The combined weighing and pointing apparatus 100 may include a housing 110 and a housing cover 120. The housing 110 may further include a base 130 configured with a weighing platform 140. In some aspects, the weighing platform 140 may be positioned on top of the base 130. The weighing platform 140 may function to support an item to be weighed by the combined weighing and pointing apparatus 100. In some aspects, the weighing platform 140 may include a weighing platform cover (not shown). The weighing platform cover (not shown) may also serve as a weighing tray for containing items on the weighing platform 140.

The base 130 may further include a display 150 for presenting information (e.g., weight or mass data). The display 150 may include electrical (e.g., digital reading), mechanical (e.g., needle reading) or any other functionality suitable for presenting data. The display 150 may be configured as an opening in the base 130 covered by or containing a sheet of material (e.g., plastic or glass). In some aspects, the display 150 may be integrally molded within the base 130 of the housing 110 or formed separately from the base 130 in which case, the display 150 may then be secured and sealed to the base 130.

The base 130 may further include user-control buttons 155 to be operated by users when using the combined weighing and pointing apparatus 100 for weighing (e.g., scale). The user-control buttons 155 may be used to adjust measurement settings and directly measure items to be weighed on the weighing platform 140. In some aspects, the user-control buttons 155 may be positioned adjacent to the display 150.

One or more controllers 160 may also be positioned on the base 130 of the apparatus 100. The controllers 160 may be operated by users when using the apparatus 100 as a pointing device (e.g., a computer mouse). In certain aspects, the controllers 160 may be in the form of buttons. For example, in some aspects, the controllers 160 may include a button positioned on a left side 162 of the base 130 and a button positioned on the right side 164 of the base 130. These buttons may be used for selecting or accessing menu items on a computer display screen or for any other suitable functionality. In some aspects, the controllers 160 may include a turning wheel 166 providing a scrolling function. In some aspects, wheel 166 may function as a button in addition to or instead of the scrolling function.

The base 130 may include a weighing mechanism (not shown) according to some aspects. The weighing mechanism may be used to determine the weight of an item placed on the weighing platform 140. The weighing mechanism may be any suitable mechanism, such as a load cell or a weight sensor, and may include force and/or pressure-responsive devices. In some aspects, the weighing mechanism may be a sensor that communicates a measurement as one or more electrical signals to the display 150, thus visually showing the weight of the item on the weighing platform 140 as a digital reading.

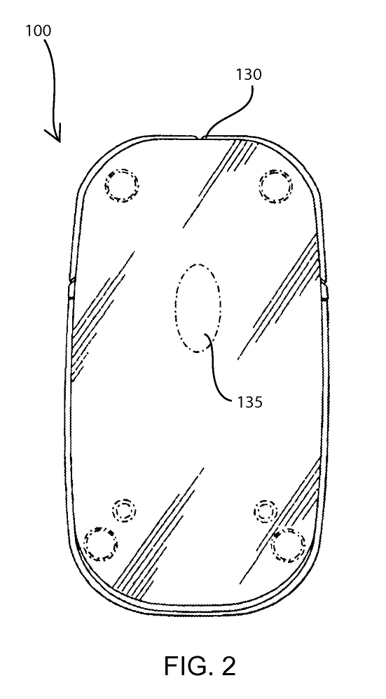

The base 130 may additionally include a motion mechanism (not shown). Movement of the motion mechanism may be translated by a computer, which in turn, corresponds to movement of a cursor on a computer screen. In some aspects, as shown in FIG. 2, the motion mechanism may be positioned at the bottom of the base 130 and may have access to the external environment through an opening 135 in the base 130. In certain aspects, the motion mechanism may be a sensor having a rubber or metal ball or an optical sensor.

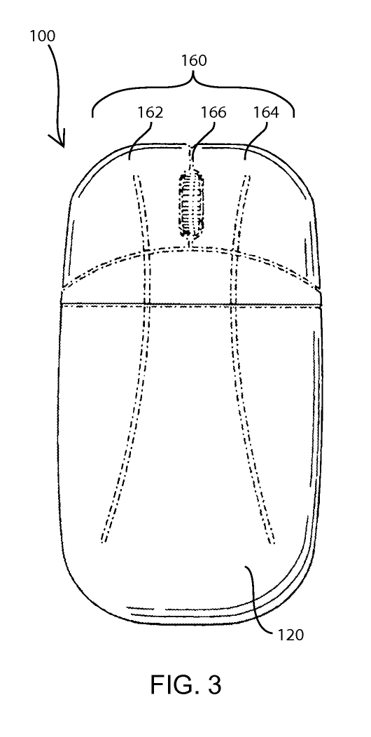

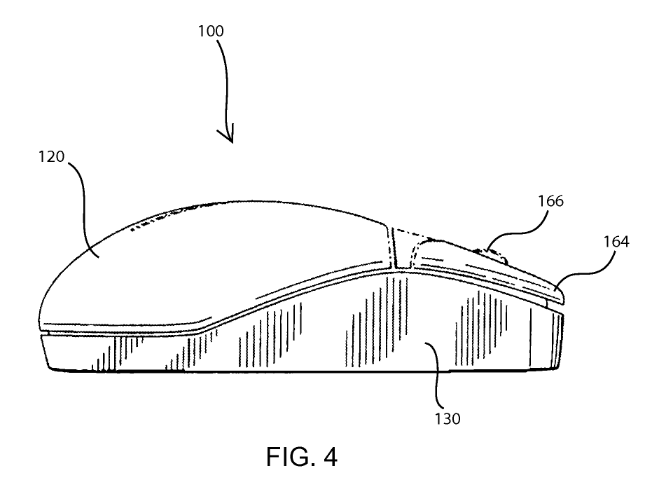

In certain aspects, the base 130 may include one or more tracks in which the housing cover 120 slides along when covering at least a portion of the housing 110. As shown in FIGS. 3 and 4, when the housing cover 120 is positioned partially or fully on the housing 110, the combined weighing and pointing apparatus 100 not only resembles a typical pointing device, such as a computer mouse, but may indeed function as one. To this end, the controllers 160 may be in communication with the motion mechanism for operating a cursor on a computer display screen. Therefore, a cursor on a computer display screen is moved by the motion of the user's hand when holding the combined weighing and pointing apparatus 100.

Some aspects of the combined weighing and pointing apparatus 100 may include a power source (not shown). In some aspects, the power source may be any type of battery or DC power from a cable. For example, the power source may come from a cable comprising an electrical wire that connects a circuit substrate contained within the housing 110 of the combined weighing and pointing apparatus 100. In certain aspects, the power source may come from a USB cable.

In some aspects, the combined weighing and pointing apparatus 100 may be wired to a computer terminal (e.g., a wired computer mouse) or, in other aspects, the apparatus 100 may be wireless (e.g., a wireless computer mouse).

Additional aspects of the disclosed apparatus embodiments include transmitting weight or mass data measured by the weighing mechanism to a computer to which the apparatus 100 is connected. For example, in some aspects, weight data measured by the measuring mechanism may be transmitted to a computer through an MCU and USB to a UART bridge and the computer's USB port. In some aspects, the apparatus 100 may include a wireless signal generator, where the wireless signal generator sends to a computer a signal corresponding to the weight of an item. In certain aspects, the computer receiving the signal may be the same computer associated with the apparatus 100.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. Other embodiments may be within the scope of the following claims.

What is claimed is:

1. A combined weighing and pointing apparatus comprising a housing and a housing cover, the housing having a base that includes:
a weighing platform positioned on top of the base;
a display for presenting information;
a weighing mechanism for weighing an item on the weighing platform; and
a motion mechanism that translates movement of the apparatus into a movement of a cursor on a display screen.

2. The apparatus of claim 1, wherein the weighing platform includes a weighing platform cover.

3. The apparatus of claim 2, wherein the weighing platform cover functions as a weighing tray for containing items to be weighed on the weighing platform.

4. The apparatus of claim 1, wherein the display is a window within the base.

5. The apparatus of claim 1, wherein the display is integrally molded with the base.

6. The apparatus of claim 1, wherein the display is formed separately from the base.

7. The apparatus of claim 1, further comprising one or more user-control buttons to be operated by a user when using the apparatus as a weighing device.

8. The apparatus of claim 7, wherein the one or more user-control buttons function to adjust measurement settings and directly measure items on the weighing platform.

9. The apparatus of claim 1, further comprising one or more controllers positioned on the base.

10. The apparatus of claim 9, wherein the one or more controllers are configured to be operated by users when using the apparatus as a pointing device.

11. The apparatus of claim 10, wherein the controllers select and access items on a computer screen.

12. The apparatus of claim 1, wherein the weighing mechanism is a load cell or a weight sensor.

13. The apparatus of claim 12, wherein the motion mechanism is a sensor having a rubber or metal ball.

14. The apparatus of claim 12, wherein the motion mechanism is an optical sensor.

15. The apparatus of claim 1, wherein the apparatus functions as a computer mouse when the housing cover is in place.

16. The apparatus of claim 1, wherein weight data measured by the weighing mechanism is transmitted to a computer.
